(19) United States
(12) Patent Application Publication
(10) Pub. No.: US 2008/0117196 A1
(43) Pub. Date: May 22, 2008

(54) DISPLAY DEVICE AND DRIVING METHOD THEREOF

(75) Inventors: Sung-Soo LEE, Suwon-si (KR); Chang-Woong CHU, Suwon-si (KR); Ji-Hye CHOI, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/775,627

(22) Filed: Jul. 10, 2007

(30) Foreign Application Priority Data
Nov. 22, 2006 (KR) 10-2006-0115681

(51) Int. Cl. G09G 3/32

(52) U.S. Cl. 345/208; 345/77

(57) ABSTRACT

A display device includes a pixel having a switch device, a driving device connected to the switch device, and a light emitting element to emit light based on a data signal provided to the driving device, a scanning driver to provide a scanning signal to the switch device, and a data driver to provide the data signal to the driving device in response to the scanning signal. The light emitting element is provided with a forward bias for a display period and with a reverse bias for a non-display period. The reverse bias applied to the light emitting element restores the internal resistance of the light emitting element, thereby releasing the luminance decrease of the light emitting element.

### CROSS-REFERENCE TO RELATED APPLICATION

This application claims priority from Korean Patent Application No. 10-2006-0115681 filed on Nov. 22, 2006, the disclosure of which is hereby incorporated herein by reference in its entirety for all purposes.

### BACKGROUND

1. Field of the Invention

The present invention relates generally to a display device, a driving method thereof and in particular to an organic light emitting display (OLED) device and a driving method thereof.

2. Description of Related Art

Many consumers want electronic devices with displays to be light and thin. Examples of such electronic devices includes mobile communication systems, digital cameras, notebook PCs, monitors, and televisions. One method of reducing display size and weight is to use flat panel displays, such as organic light emitting displays (OLED).

One type of active matrix flat panel display is an active matrix flat panel display. An active matrix flat panel display generally includes a plurality of pixels arranged in a matrix and displays images by controlling the luminance of the pixels based on luminance information indicative of a desired image.

An OLED is self-emissive. OLEDs have desirable characteristics such as a relatively wide viewing angle, a relatively fast response time, and a relatively high contrast ratio when compared to liquid crystal displays (LCDs). Further, because an OLED does not require a backlight assembly, OLEDs are lighter and consume less power than LCDs.

A pixel of an OLED includes a light emitting element and a driving transistor. The light emitting element emits light having an intensity value that is dependent on the current driven by the driving transistor, which in turn depends on the threshold voltage of the driving transistor and the voltage between a gate and source of the driving transistor.

### SUMMARY OF THE INVENTION

However, the internal resistance of the light emitting element increases over time, thereby causing a decrease in luminance of the OLED. This may degrade image quality.

Thus, there is a need for reducing the resistance increase of the light emitting element.

Embodiments of the present invention provide a display device capable of reducing the resistance increase of the light emitting element and a driving method thereof to reduce image degradation.

In an exemplary display device according to some embodiments of the present invention, the display device includes a pixel having a switch device, a driving device connected to the switch device and a light emitting element to emit light based on a data signal provided to the driving device, a scanning driver to provide a scanning signal to the switch device, and a data driver to provide the data signal to the driving device in response to the scanning signal. The light emitting element is provided with a forward bias for a first period and with a reverse bias for a second period.

The driving device includes a control terminal to receive the data signal from the data driver, a first terminal connected to a first voltage and a second terminal connected to the light emitting element. The light emitting element has a first terminal connected to the driving device and second terminal connected to a second voltage.

The forward bias is formed by the first voltage higher than the second voltage, and the reverse bias is formed by the second voltage higher than the first voltage. The first voltage can swing and the second voltage can be constant or, the first voltage and the second voltage can swing, thereby forming the reverse bias.

The data driver provides a data signal for the first period and a turn-on voltage for the second period to the control terminal.

The light emitting element is an organic light emitting diode.

In an exemplary display device according to another embodiment of the present invention, the display device includes a plurality of gate lines, a plurality of data lines across the gate line, and a plurality of pixels connected to the gate lines and the data lines, wherein each pixel includes a light emitting element to emit light, a switch connected to the associated gate line, and a current controller connected between the associated light emitting element and the associated switch and to control current flowing through the light emitting element, wherein the light emitting element is provided with a first bias and a second bias opposite to the first bias.

The current controller is connected to a first voltage and the light emitting element is connected to a second voltage.

The first bias is formed by the first voltage higher than the second voltage and the second bias is formed by the second voltage higher than the first voltage. In one embodiment, the first voltage can swing and the second voltage can be constant. In another embodiment, the first and the second voltages can swing.

An exemplary method of driving a display device according to an embodiment of the present invention includes displaying images for a first period, and applying reverse bias to the light emitting element for a second period.

The display device includes a plurality of pixel having a switch, a current controller, and a light emitting element electrically connected between a first voltage and a second voltage.

Displaying images includes providing data signals to the current controller through the switch, flowing currents driven by the current controller to the light emitting element based on the data signals, and emitting lights by the light emitting element.

Applying the reverse bias to the light emitting element includes providing a turn-on voltage to the current controller, and providing the first voltage higher than the second voltage to the light emitting element through the current controller.

In one embodiment, the first voltage can swing and the second voltage can be constant during the first and the second periods. In another embodiment, the first voltage and the second voltage can swing during the first and the second periods. The light emitting element is an organic light emitting diode.

### BRIEF DESCRIPTION OF THE DRAWINGS

The features of the present invention will become more apparent to those of ordinary skill in the art in light of the below described exemplary embodiments thereof with reference to the attached drawings, in which:

FIG. 1 is a block diagram of an OLED according to an embodiment of the present invention;

FIG. 2 is an equivalent circuit diagram of a pixel of the OLED of FIG. 1;

FIG. 3 is a timing diagram illustrating several signals for operating an OLED such as the OLED of FIG. 1 according to an embodiment of the present invention;

FIG. 4 is a graph illustrating characteristics of a general light emitting element of an OLED;

FIG. 5 is a graph illustrating characteristics of a light emitting element of an OLED such as the OLED of FIG. 1 according to an embodiment of the present invention; and,

FIG. 6 is a timing diagram illustrating several signals for operating an OLED such as the OLED of FIG. 1 according to another embodiment of the present invention.

Use of the same reference symbols in different figures indicates similar or identical items.

### DETAILED DESCRIPTION OF PREFERRED EMBODIMENTS

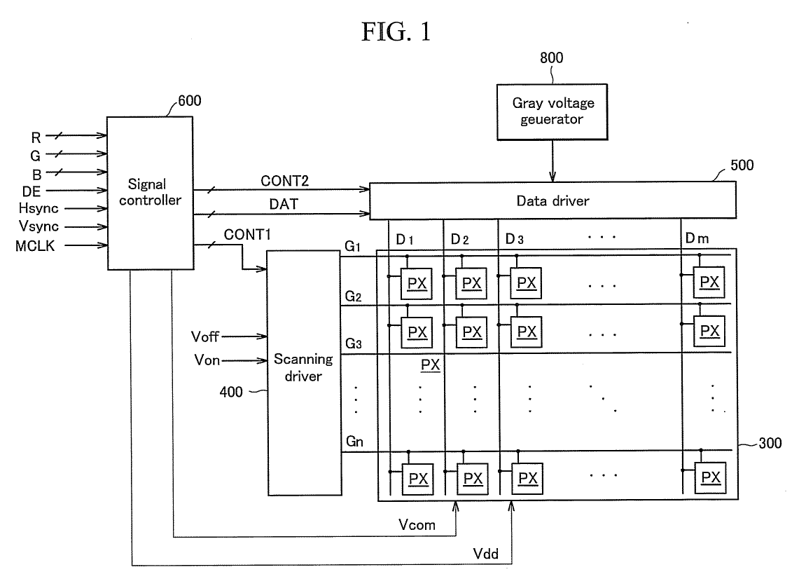

FIG. 1 is a block diagram of an OLED according to an embodiment of the present invention.

Referring to FIG.1, an OLED includes a display panel 300, as well as a scanning (i.e. gate) driver 400, a data driver 500, a gray voltage generator 800, and a signal controller 600 connected to the display panel 300.

Display panel 300 includes gate lines G₁-Gₙ, data lines D₁-Dₘ, power supply lines (not shown), and a plurality of pixels Px.

Gate lines G₁-Gₙ carry scanning (i.e. gate) signals and extend substantially parallel to one another, in a horizontal direction (in the example shown in FIG. 1). Data lines D₁-Dₘ carry data signals and extend substantially parallel to one another in a vertical direction. Power supply lines (not shown) carry power supplying voltages (i.e. driving voltages) and may extend in a horizontal or a vertical direction.

In the embodiment illustrated in FIG. 1, pixels are arranged in a matrix configuration and are connected to gate lines G₁-Gₙ, data lines D₁-Dₘ, and power supply lines.

Scanning driver 400 provides scanning signals to gate lines G₁-Gₙ, where the scanning signals are either Voff (a voltage sufficient to turn off the associated transistor) or Von (a voltage sufficient to turn on the associated transistor).

Data driver 500 provides data voltages (or data signals) to data lines D₁-Dₘ corresponding to image signals.

Gray voltage generator 800 generates and outputs reference voltages to the data drivers 500 by using analog voltage.

Signal controller 600 controls scanning driver 400, and data driver 500. Image signals (e.g., R, G, and B signals), and input control signals, such as a vertical synchronization signal V_{sync} to activate a frame, a horizontal synchronization signal H_{sync} to activate a line, and a main clock MCLK from an external graphic controller (not shown), are provided to signal controller 600. Signal controller 600 generates scanning control signals CONT1, and data control signals CONT2 by processing input control signals. Signal controller 600 also converts image signals R, G, and B to image data DAT suitable for display panel 300. Signal controller 600 may include a frame memory (not shown) or a look-up-table LUT (not shown) to generate image data DAT.

Scanning control signals CONT1 include a scanning start signal STV to initiate scanning and at least one clock signal for controlling the output time of the gate-on voltage Von. The scanning control signals CONT1 may include a plurality of output enable signals OE for defining the duration of the gate-on voltage Von.

The data control signals CONT2 include a horizontal synchronization start signal STH for initiating data transmission for a group of pixels Px, a load signal LOAD instructing data driver 500 to apply the data voltages to the data lines D₁-Dₘ, and a data clock signal HCLK.

A voltage generator (not shown) which outputs power supply voltages Vdd (i.e. driving voltages) and common voltages Vcom applied to display panel 300, can be included in or formed separately from signal controller 600.

In some embodiments, scanning driver 400, data driver 500, gray voltage generator 800 and/or signal controller 600 are included in chips mounted directly on display panel 300, or on flexible printed circuit films. In some embodiments, scanning driver 400, data driver 500, gray voltage generator 800 and/or signal controller 600 can be integrated on display panel 300. Scanning driver 400, data driver 500, gray voltage generator 800 and/or signal controller 600 can be integrated on a single chip or at least one of them can be included in a separate chip.

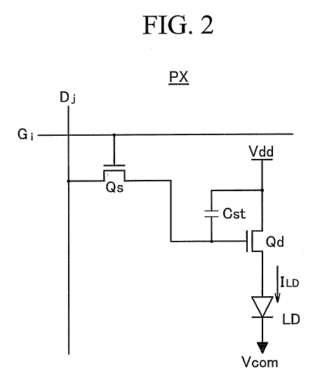

FIG. 2 is a pixel Px of an OLED such as that illustrated in FIG. 1, according to an embodiment of the present invention.

Pixel Px connected to i-th gate line Gᵢ and j-th data line Dⱼ includes a switch transistor Qs, a driving transistor Qd, a capacitor Cst, and a light emitting element LD.

Switch transistor Qs has a control terminal connected to the associated gate line Gᵢ, an input terminal connected to the associated data line Dⱼ, and an output terminal connected between capacitor Cst and driving transistor Qd. Switch transistor Qs carries a data signal from data line Dⱼ to driving transistor Qd in response to a scanning signal provided by scanning line Gᵢ.

Driving transistor Qd has a control terminal connected to switch transistor Qs and capacitor Cst, an input terminal connected to driving voltage Vdd, and an output terminal connected to light emitting element LD. Driving transistor Qd drives an output current I_{LD} (i.e. driving current I_{LD}) that is dependent on the voltage difference Vgs between the control terminal of driving transistor Qd and the output terminal of driving transistor Qd.

Capacitor Cst is connected between switch transistor Qs and driving voltage Vdd, and holds a data voltage provided through switch transistor Qs from data line Dⱼ during a desired period even after switch transistor Qs turns off.

Light emitting element LD is connected between driving transistor Qd and a common voltage Vcom. Light emitting element LD emits light having intensity depending on the driving current I_{LD} of driving transistor Qd. Driving current I_{LD} depends on the voltage difference Vgs between the control terminal of driving transistor Qd and the output terminal of driving transistor Qd. In one embodiment, light emitting element LD is a light emitting diode including an anode connected to the output terminal of driving transistor Qd and a cathode connected to common voltage Vcom.

Light emitting element LD uniquely emits one of a set of primary color lights, depending on the material thereof. An exemplary set of primary colors includes three primary colors: red, green, and blue. The display of images is realized by the addition of the three primary colors. In another embodiment, light emitting element LD can emit white color light.

In some embodiments, the switch transistors Qs and the driving transistors Qd are n type transistors including amorphous silicon or polysilicon. However, in some embodiments the transistors Qs and/or Qd may be p type transistors operating in a manner opposite to n type transistors. The connection between switch transistor Qs, driving transistor Qd, capacitor Cst, and light emitting element LD can be adjusted. For example, capacitor Cst may be connected between the control terminal and the output terminal of driving transistor Qd instead of the input terminal as shown in FIG. 2.

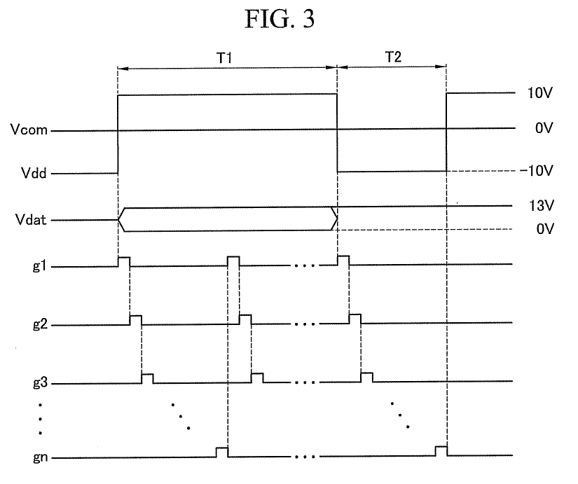

FIG. 3 is a timing diagram illustrating several signals for operating an OLED such as that illustrated in FIG. 1 according an embodiment of the present invention.

Signal controller 600 of FIG. 1 controls data driver 400, scanning driver 400, data driver 500, and display panel 300 during a display period T1 and a non-display period T2 respectively in different manners. During display period T1, data driver 500 convert image data DAT received from signal controller 600 of FIG. 1 into data voltages Vdat in response to data control signals CONT2. Scanning driver 400 outputs scanning signals g1 to gn in response to scanning control signals CONT1 of FIG. 1. The voltage generator (not shown) keeps common voltage Vcom constant and driving voltage Vdd higher than common voltage Vcom. In one embodiment, common voltage Vcom is OV, and driving voltage Vdd is 10V.

When the scanning signal is gate-on voltage Von, switch transistor Qs of the associated pixel Px of FIG. 2 turns on, and the data voltage Vdat is provided to driving transistor Qd through switch transistor Qs. Driving transistor Qd outputs driving current I_{LD} to light emitting element LD corresponding to the applied data voltage Vdat. Light emitting element LD emits light having intensity value depending on driving current I_{LD}.

By repeating this procedure for each gate line, all gate lines G₁-Gₙ are sequentially supplied with the gate-on voltage Vₒₙ during first period T₁, thereby applying the data voltages to all pixels to display an image for a frame. For display period T1, a plurality of frame can be displayed and the number of display frame can be adjusted.

Non-display period T2 starts after display period T1 elapses and the image display ends.

During non-display period T2, signal controller 600 receives no input image signals (e.g. R, G, and B signals), and controls the voltage generator to keep common voltage constant and driving voltage Vdd lower than common voltage. In one embodiment, while common voltage Vcom is 0V, the driving voltage Vdd is −10V.

Data driver 500 outputs data voltage Vdat having a level of turning on driving transistor Qd in response to data control signal CONT2 received from signal controller 600.

Scanning driver 400 outputs scanning signals g1 to gn to gate lines G₁ to Gₙ in response to scanning control signal CONT1.

When the scanning signal is gate-on voltage Von, switch transistor Qs of the associated pixel Px of FIG. 2 turns on, and the data voltage Vdat is provided to driving transistor Qd, thereby turning on driving transistor Qd. When the driving transistor turns on, driving voltage Vdd is provided to the anode of light emitting element LD. Common voltage Vcom is applied to cathode of light emitting element LD. During non-display period T2, a reverse bias is applied to light emitting element LD since driving voltage Vdd is lower than common voltage Vcom, thereby turning off light emitting element LD. By repeating this procedure for each gate line, the internal resistance which increases during display period T1 can be compensated and reduced.

The length of each period T1 and T2 can be adjusted.

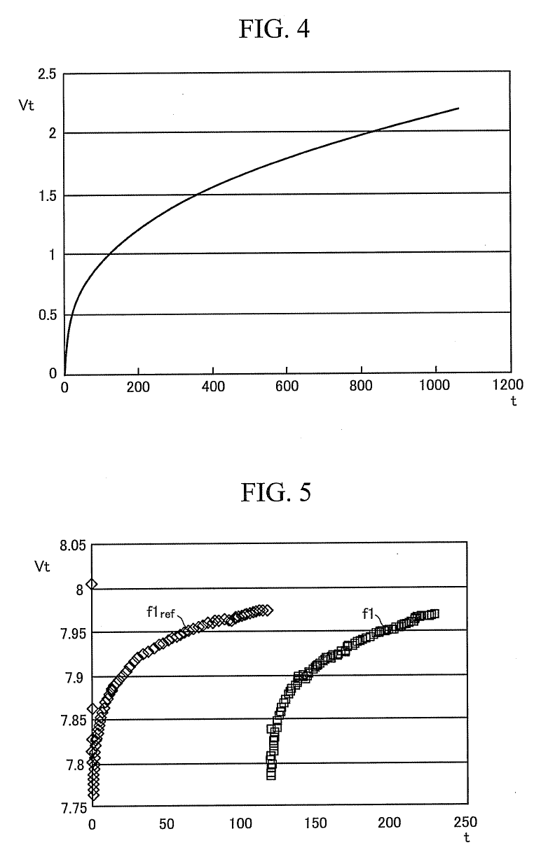

Hereinafter, the effect of the present invention will be described referring to FIG. 4 and 5.

FIG. 4 is a graph illustrating that the voltage Vt applied to light emitting element LD increases over time to emit a determined amount of light. This is because the internal resistance of light emitting element LD increases.

Referring to FIGS. 2 to 4, driving transistor Qd and light emitting element LD are connected in serial between driving voltage Vdd and common voltage Vcom. When both driving transistor Qd and light emitting element LD turn on, the voltage difference between driving voltage Vdd and light emitting element LD is divided and applied to driving transistor Qd and light emitting element LD depending on each internal resistance.

The increase of the internal resistance of light emitting element LD causes the voltage Vt to increase, thereby increasing the output terminal voltage of driving transistor Qd and reducing a voltage difference Vgs between the control terminal and the output terminal of driving transistor Qd. The driving current ILD decreases as Vgs decreases over time as shown in equation I below.

I_{LD}=K(Vgs−Vth)2 (1),

where Vgs is a voltage difference between the control terminal of the driving transistor and the output terminal of the driving transistor, and Vth is a threshold voltage of the driving transistor.

Accordingly, the luminance of the light emitting element LD decreases depending on the decease of the driving current I_{LD}.

FIG. 5 is a graph of the voltage Vt applied to light emitting element LD over time according to an embodiment of the present invention. The voltage Vt increases during the display period TI of FIG. 3 (f1ref curve). After the display period T1 ends, a reverse bias −10V is provided to light emitting element LD for 45 hours during the non-display period T2 of FIG. 3. When the non-display period T2 ends and the display period TI starts again, the measured voltage Vt is substantially equal to the initial voltage Vt during the display period T1 (f1 curve). Accordingly, the reverse bias applied to light emitting element LD during the non-display period suppresses to increase continuously the voltage Vt and restores the internal resistance of light emitting element LD, thereby releasing the luminance decrease of light emitting element LD.

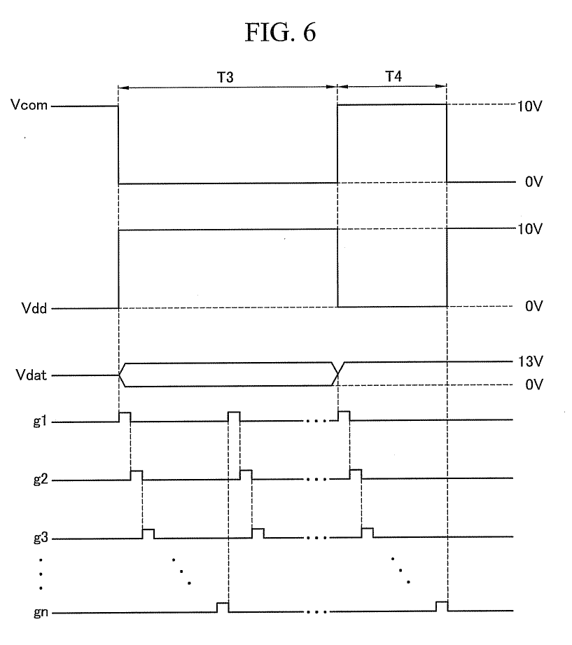

FIG. 6 is a timing diagram illustrating several signals for operating an OLED such as the OLED of FIG. 1 in accordance with another embodiment of the present invention. The timing diagram of FIG. 6 is substantially identical to the timing diagram of FIG. 3 except for the levels of driving voltage Vdd and common voltage Vcom.

Driving voltage Vdd is high and common voltage Vcom is low during a display period T3, while driving voltage Vdd is low and common voltage Vcom is high during a non-display period T4. That is, driving voltage Vdd and common voltage Vcom swing in reverse during the display period T3 and the non-display period T4. Accordingly, a reverse bias is provided to the light emitting element LD during the non-display period T4. In one embodiment, both driving voltage Vdd and common voltage Vcom swing from 0V to 10V as shown in FIG. 6. The voltage range for swing can be adjusted.

According to some embodiments of the present invention, the reverse bias applied to light emitting element LD during the non-display period prevents a continuous increase in the voltage and restores the internal resistance of the light emitting element, thereby releasing the luminance decrease of light emitting element LD.

Although the invention has been described with reference to particular embodiments, the description is an example of the invention's application and should not be taken as a limitation. Various adaptations and combinations of the features of the embodiments disclosed are within the scope of the invention as defined by the following claims.

1. A display device comprising:
a pixel including a switch device, a driving device connected to the switch device and a light emitting element that emits light based on a data signal provided to the driving device, the light emitting element provided with a forward bias for a first period and with a reverse bias for a second period;
a scanning driver that provides a scanning signal to the switch device; and, a data driver that provides the data signal to the driving device in response to the scanning signal.

2. The display device of the claim 1, wherein the driving device comprises a control terminal configured to receive the data signal from the data driver, a first terminal connected to a first voltage and a second terminal connected to the light emitting element.

3. The display device of the claim 2, wherein the light emitting element comprises a first terminal connected to the driving device and a second terminal connected to a second voltage.

4. The display device of the claim 3, wherein the forward bias is formed by the first voltage higher than the second voltage, and the reverse bias is formed by the second voltage higher than the first voltage.

5. The display device of the claim 4, wherein the first voltage swings and the second voltage is constant.

6. The display device of the claim 4, wherein the first voltage and the second voltage swing.

7. The display device of the claim 5, wherein the data driver provides a data signal for the first period and a turn-on voltage for the second period to the control terminal.

8. The display device of the claim 4, wherein the light emitting element is an organic light emitting diode.

9. A display device comprising:
a plurality of gate lines;
a plurality of data lines across the gate lines; and
a plurality of pixels connected to the gate lines and the data lines, each of the pixel comprising,
a light emitting element configured to emit light;
a switch connected to the associated gate line; and,
a current controller connected between the associated light emitting element and the associated switch and the current controller controlling current flowing through the light emitting element, wherein the light emitting element is provided with a first bias and a second bias opposite to the first bias.

10. The display device of claim 9, wherein the current controller is connected to a first voltage and the light emitting element is connected to a second voltage.

11. The display device of claim 10, wherein the first bias is formed by the first voltage higher than the second voltage and the second bias is formed by the second voltage higher than the first voltage.

12. The display device of claim 11, wherein the first voltage swings and the second voltage is constant.

13. The display device of claim 11, wherein the first and the second voltages swing.

14. A method for driving a display device including a plurality of pixel having a switch, a current controller, and a light emitting element electrically connected between a first voltage and a second voltage comprising;
displaying images for a first period; and,
applying a reverse bias to the light emitting element for a second period.

15. The method of claim 14, wherein displaying images further comprises;
providing data signals to the current controller through the switch;
flowing driving currents to the light emitting element by the current controller based on the data signals; and,
emitting lights by the light emitting element.

16. The method of claim 15, wherein applying the reverse bias to the light emitting element further comprises;
providing a turn-on voltage to the current controller; and,
providing the first voltage higher than the second voltage to the light emitting element.

17. The method of claim 16, wherein the first voltage swings and the second voltage is constant during the first and the second periods.

18. The method of claim 16, wherein the first voltage and the second voltage swing during the first and the second periods.

19. The method of claim 18, wherein the light emitting element is an organic light emitting diode.

20. The display device of the claim 6, wherein the data driver provides a data signal for the first period and a turn-on voltage for the second period to the control terminal.
